(19) United States
(12) Patent Application Publication
(10) Pub. No.: US 2021/0231036 A1
(43) Pub. Date: Jul. 29, 2021

(54) MUFFLER SYSTEM

(71) Applicant: FUTABA INDUSTRIAL CO., LTD., Okazaki-shi (JP)

(72) Inventors: Masahiro Kajikawa, Okazaki-shi (JP); Masaya Takeuchi, Okazaki-shi (JP); Masayuki Sudoh, Okazaki-shi (JP)

(21) Appl. No.: 17/145,253

(22) Filed: Jan. 8, 2021

(30) Foreign Application Priority Data
Jan. 24, 2020 (JP) 2020-010183

(51) Int. Cl. F01N 1/06; F01N 1/02; F01N 1/08; F01N 13/02; G10K 11/172; G10K 11/16

(52) U.S. Cl. CPC F01N 1/06; F01N 1/02; F01N 1/089; F01N 13/02; F01N 2210/06; G10K 11/161; F01N 2210/02; F01N 2210/04; G10K 11/172

(57) ABSTRACT

The present disclosure provides a muffler system that can effectively reduce exhaust noises. The muffler system includes an exhaust passage and a first muffler. The exhaust passage is configured to allow a flow of an exhaust gas. The first muffler is an expansion chamber muffler and disposed in the exhaust passage. The first muffler is situated upstream of a first position in a flow direction of the exhaust gas. The first position is located away from an upstream end of the exhaust passage by one third of an entire length of the exhaust passage.

### CROSS-REFERENCE TO RELATED APPLICATION

The present application claims the benefit of Japanese Patent Application No. 2020-010183 filed on Jan. 24, 2020 with the Japan Patent Office, the entire disclosure of which is incorporated herein by reference.

### BACKGROUND

The present disclosure relates to a muffler system.

One disclosed silencer reduces noise generated while a motor of a methanol-type battery is being driven (see Japanese Unexamined Patent Application Publication No. 2012-128230). The silencer includes a conduit and first to fourth mufflers provided to the conduit.

The first muffler is a side branch pipe and situated at a position that is located away from the open downstream end of the conduit toward the upstream side of the conduit by one fourth of a wavelength λ₁. The wavelength λ₁ corresponds to the fundamental frequency f₁. The second and third mufflers are Helmholtz resonators and situated at respective positions that are located away from the open downstream end toward the upstream side of the conduit by one fourth of the respective wavelengths λ₂, λ₃. The wavelengths λ₂, λ₃ respectively correspond to the higher-order frequencies f₁, f₃ that are integer multiples of the fundamental frequency. The fourth muffler is an expansion chamber muffler and disposed between the opening at the upstream end of the conduit and the first muffler.

### SUMMARY

It is desirable that one aspect of the present disclosure provides a muffler system that can effectively reduce exhaust noises.

One aspect of the present disclosure provides a muffler system. The muffler system includes an exhaust passage and a first muffler. The exhaust passage is configured to allow a flow of an exhaust gas. The first muffler is an expansion chamber muffler and disposed in the exhaust passage. The first muffler is situated upstream of a first position in a flow direction of the exhaust gas. The first position is located away from an upstream end of the exhaust passage by one third of an entire length of the exhaust passage.

In this configuration, the first muffler, which is an expansion chamber muffler, is situated in a portion of the exhaust passage where the sound pressures of stationary waves apply (specifically, in a portion where the sound pressures are not zero). The stationary waves respectively have natural vibration modes of a first mode and a second mode, and are formed in the exhaust passage. The first muffler is situated close to the antinode of the first mode, as compared with a configuration in which the first muffler is situated at the first position, which is located away from the upstream end of the exhaust passage by one third of the entire length of the exhaust passage, or situated at a position located downstream of the first position. Accordingly, this configuration effectively reduces the stationary waves of both the first mode and the second mode, thereby effectively reducing exhaust noises.

As long as the same effects as those described above can be achieved, the first muffler does not have to be situated upstream of the first position in a strict sense. That is, as long as the same effects as those described above can be achieved, the first muffler can be situated at a position located slightly downstream of the first position.

In one aspect of the present disclosure, the muffler system may further include a second muffler. The second muffler is disposed downstream of the first muffler in the exhaust passage. The second muffler is either a resonance type muffler or an expansion chamber muffler.

In this configuration, the exhaust noises can be effectively reduced as compared with the case where the muffler system is provided only with the first muffler.

In one aspect of the present disclosure, the second muffler may be the resonance type muffler.

This configuration provides a muffling effect due to a resonance phenomenon that occurs in the resonance type muffler. This configuration also contributes to reducing the size of the second muffler, which is the resonance type muffler.

In one aspect of the present disclosure, the second muffler may be the expansion chamber muffler.

In the above-described configuration, the frequencies of the stationary waves formed in the exhaust passage can be further increased. Making the stationary waves high-frequency waves leads to reducing the sound pressure levels of the stationary waves in low frequencies, which in turn reduces noises.

In one aspect of the present disclosure, the second muffler may be situated at a position where an antinode of a stationary wave is formed by the first muffler.

In the above-described configuration, the stationary wave can be effectively reduced as compared with a configuration in which the second muffler is situated at a position other than the position of the antinode of the stationary wave.

In one aspect of the present disclosure, the second muffler may be situated at a position where an antinode of a stationary wave of a first mode is formed by the first muffler.

In the above-described configuration, the stationary wave of the first mode can be effectively reduced as compared with a configuration in which the second muffler is situated at a position other than the position of the antinode of the stationary wave of the first mode.

In one aspect of the present disclosure, the second muffler may be situated at a position where an antinode of a stationary wave of a second mode is formed by the first muffler.

In the above-described configuration, both the stationary wave of the first mode and the stationary wave of the second mode can be effectively reduced.

In one aspect of the present disclosure, the muffler system may further include a third muffler. The third muffler is disposed downstream of the first muffler in the exhaust passage. The third muffler is either a resonance type muffler or an expansion chamber muffler. The second muffler may be situated at a position where an antinode of a stationary wave of a first mode is formed by the first muffler. The third muffler may be situated at a position where an antinode of a stationary wave of a second mode is formed by the first muffler.

In the above-described configuration, both the stationary wave of the first mode and the stationary wave of the second mode can be effectively reduced.

### BRIEF DESCRIPTION OF THE DRAWINGS

Embodiments of the present disclosure will be described hereinafter by way of example with reference to the accompanying drawings, in which:

FIG. 1 is a schematic diagram showing a configuration of a muffler system according to a first embodiment;

FIG. 2 is a diagram showing waveforms of stationary waves formed in an exhaust passage in a case where a first muffler and a second muffler are not installed;

FIG. 3 is a diagram showing waveforms of stationary waves formed by the first muffler;

FIG. 4 is a diagram showing the muffler system in which the second muffler is situated at a position where an antinode of a stationary wave of a second mode is formed by the first muffler;

FIG. 5 is a diagram showing waveforms of stationary waves formed in the exhaust passage in a case where the first and second mufflers are both expansion chamber mufflers and installed in the exhaust passage; and

FIG. 6 is a schematic diagram showing a muffler system including three mufflers.

### DETAILED DESCRIPTION OF EXEMPLARY EMBODIMENTS

### 1. First Embodiment

### 1-1. Configuration

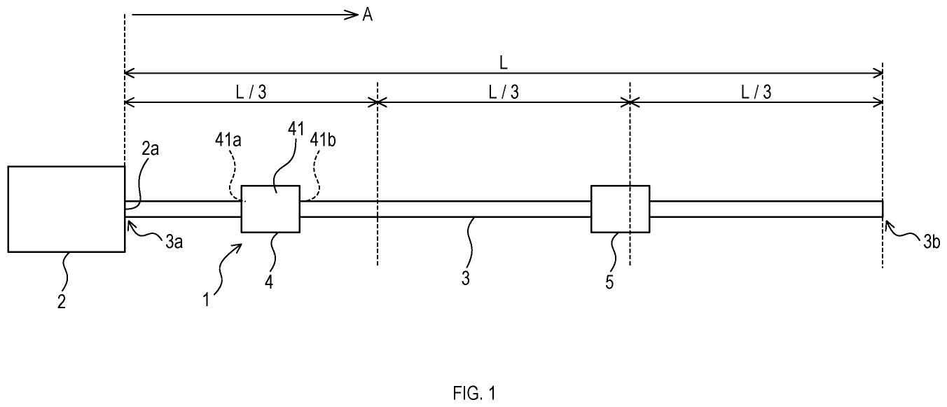

With reference to FIG. 1, a muffler system 1 reduces noises of an exhaust gas discharged from an engine 2. The muffler system 1 comprises an exhaust passage 3, a first muffler 4, and a second muffler 5.

<Exhaust Passage>

The exhaust passage 3 allows a flow of the exhaust gas discharged from the engine 2. The exhaust passage 3 has one end connected to an exhaust port 2a at one end of the engine 2, while the other end is open to outside the exhaust passage 3.

In FIG. 1, the exhaust passage 3 is shown as a linear pipe; the exhaust passage 3, however, may be curved.

Hereinafter, the end (specifically, end face) of the exhaust passage 3 in the upstream side of a flow direction A will be referred to as an upstream end 3a, whereas the other end (specifically, end face) in the downstream side of the flow direction A will be referred to as a downstream end 3b. The flow direction A is the way the exhaust gas discharged from the engine 2 flows.

The length of the exhaust passage 3 from the upstream end 3a to the downstream end 3b will be referred to as an “entire length L” of the exhaust passage 3. In other words, the length from one end of the engine 2 (specifically the exhaust port 2a) to the downstream end 3b of the exhaust passage 3 will be referred to as the “entire length L”.

<First Muffler>

The first muffler 4 is an expansion chamber muffler and disposed in the exhaust passage 3. Specifically, the first muffler 4 comprises an expansion chamber 41 disposed between the two ends of the exhaust passage 3. The expansion chamber 41 comprises a hollow therein with a cross-sectional area larger than that of the exhaust passage 3. The exhaust gas expands in the expansion chamber 41, and the expansion reduces the speed and the pressure of the exhaust gas. The energy of the exhaust gas that is decreased due to the expansion passes through the exit of the first muffler 4 in the amount corresponding to the opening area of the exit. The rest of the energy is reflected in the expansion chamber 41 and thereby attenuated.

In the present embodiment, the first muffler 4 is disposed upstream of a first position in the exhaust passage 3 in the flow direction A. The first position is located away from the upstream end 3a of the exhaust passage 3 by one third of the entire length L of the exhaust passage 3.

“The first muffler 4 is disposed upstream of a first position . . . located away from the upstream end 3a by one third of the entire length L” herein means that an entry 41a of the expansion chamber 41 of the first muffler 4 is disposed upstream of the first position that is located away from the upstream end 3a by one third of the entire length L. The entry 41a of the expansion chamber 41 is where sound waves of exhaust noises enter.

The location of the first muffler 4 is not limited to a specific position. The first muffler 4 may be situated at any position, provided that it is upstream of the first position. It is, however, desirable that the first muffler 4 be situated as far upstream as possible.

<Second Muffler>

The second muffler 5 is disposed downstream of the first muffler 4 in the exhaust passage 3. In the present embodiment, the second muffler 5 is a resonance type muffler.

The second muffler 5 is coupled between the first muffler 4 and the lower end 3b of the exhaust passage 3. Examples of the resonance type muffler include resonators such as side branch pipes and Helmholtz resonators.

In the present embodiment, the second muffler 5 is situated at the position where an antinode of a stationary wave is formed by the first muffler 4.

Combination of a traveling wave and a reflected wave generates the stationary wave having a node at the downstream end 3b of the exhaust passage 3. The traveling wave is a sound wave of an exhaust noise that propagates in the exhaust passage 3 toward the downstream end 3b. The reflected wave is a sound wave that is reflected at the downstream end 3b (specifically, opening) and propagates in a direction opposite to the flow direction A.

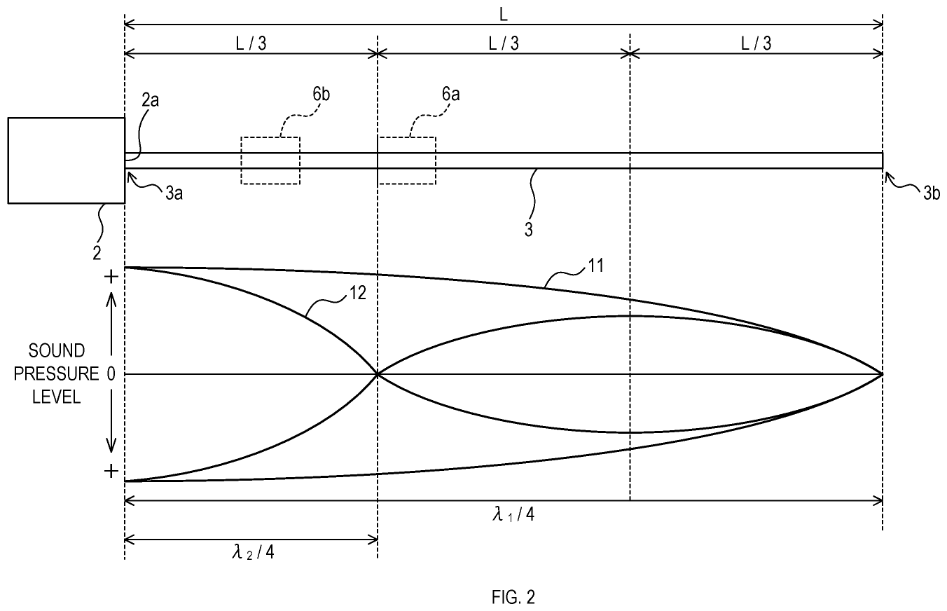

FIG. 2 shows waveforms of stationary waves that are formed in the case where the first muffler 4 and the second muffler 5 are not installed in the exhaust passage 3. Specifically, FIG. 2 shows the waveform of a stationary wave 11 having a natural vibration mode of a first mode and the waveform of a stationary wave 12 having a natural vibration mode of a second mode.

The two stationary waves 11, 12 both have antinodes at the upstream end 3a and nodes at the downstream end 3b. The entire length L of the exhaust passage 3 is expressed as follows: L=λ₁×¼, where λ₁ is the wavelength of the stationary wave 11 of the first mode; and L=λ₂×¾, where λ₂ is the wavelength of the stationary wave 12 of the second mode.

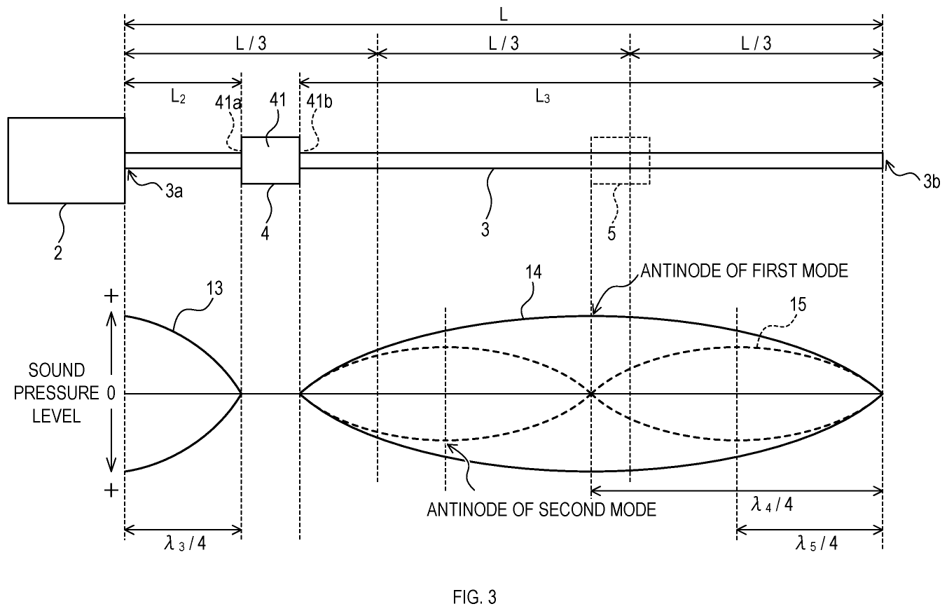

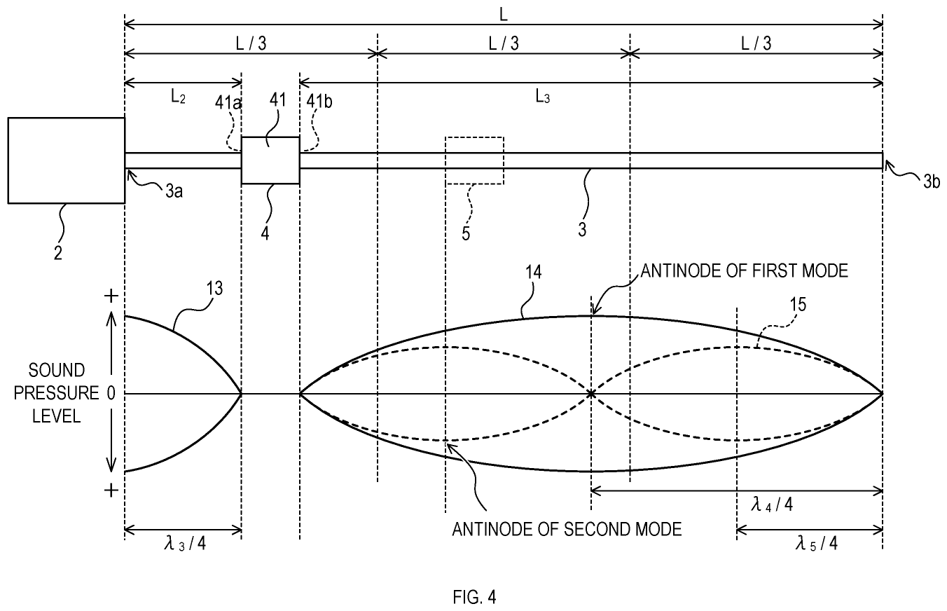

FIG. 3 shows waveforms of stationary waves formed by the first muffler 4. In other words, FIG. 3 shows the waveforms of stationary waves that are formed in the case where only the first muffler 4 (not the second muffler 5) is installed in the exhaust passage 3. FIG. 3, FIG. 4, and other figures, which will be described later, do not show any waveform of a sound wave formed inside the mufflers (such as the first muffler 4).

FIG. 3 shows a stationary wave 13 having an antinode at the upstream end 3a of the exhaust passage 3, and a node at the entry 41a of the expansion chamber 41 of the first muffler 4. FIG. 3 also shows stationary waves 14, 15 having nodes at an exit 41b of the expansion chamber 41 and at the downstream end 3b of the exhaust passage 3.

The two stationary waves 14, 15 respectively have natural vibration modes of the first and second modes. Accordingly, L₂=λ₃×¼ is established where L₂ is the distance from the upstream end 3a of the exhaust passage 3 to the entry 41a of the expansion chamber 41, and λ₃ is the wavelength of the stationary wave 13.

Moreover, L₃=λ₄×½ is established where L₃ is the distance from the exit 41b of the expansion chamber 41 to the downstream end 3b of the exhaust passage 3, and λ₄ is the wavelength of the stationary wave 14.

Further, L₃=λ₅ is established where λ₅ is the wavelength of stationary wave 15.

In the present embodiment, the second muffler 5 is situated at the position where the antinode of the stationary wave 14 of the first mode is formed by the first muffler 4. Specifically, the second muffler 5 is situated at a position that is located away from the downstream end 3b of the exhaust passage 3 toward the upstream end 3a by one fourth of the wavelength λ₄ of the stationary wave 14.

### 1-2. Effects

(1a) In the present embodiment, the expanded-type first muffler 4 is disposed upstream of the first position, which is located away from the upstream end 3a of the exhaust passage 3 by one third of the entire length L of the exhaust passage 3. Accordingly, the exhaust noises can be effectively reduced.

Assume that the first muffler 4 is installed at the first position (at the position shown with a dotted line 6a in FIG. 2). In this case, the first muffler 4 is situated in a portion of the exhaust passage 3 where the sound pressure of the stationary wave 11 of the first mode applies, and provides a sufficient muffling effect on the stationary wave 11. In terms of the stationary wave 12 of the second mode, the first muffler 4 is situated in a portion of the exhaust passage 3 where there is no sound pressure (specifically, at the node), and thereby provides a limited muffling effect on the stationary wave 12.

In the case where the first muffler 4 is disposed upstream of the first position (for example, at the position shown with a dotted line 6b in FIG. 2) as in the present embodiment, the first muffler 4 is situated in a portion of the exhaust passage 3 where the sound pressures of the stationary waves 11, 12 of the first and second modes are applied, and situated close to the antinode of the stationary wave 11 of the first mode, as compared with a configuration in which the first muffler 4 is disposed at the first position, or downstream of the first position. The stationary waves of both the first and second modes, thus, can be effectively reduced. Accordingly, the muffler system 1 of the present embodiment can effectively reduce the exhaust noises, as compared with a configuration in which the first muffler 4 is situated at the first position or downstream of the first position.

(1b) In the present embodiment, the muffler system 1 comprises the second muffler 5, which is a resonance type muffler, disposed downstream of the first muffler 4 in the exhaust passage 3. This configuration provides a muffling effect by a resonance phenomenon and contributes to reducing the size of the second muffler 5.

Specifically, noise is muffled with a resonance type muffler when the frequency of a frequency component intended to be attenuated coincides with the frequency in a resonance chamber of the resonance type muffler. In general, resonance chambers may be small in capacity if the frequencies in the resonance chambers, that is, the frequencies of the frequency components intended to be attenuated, are high.

In the present embodiment, installation of the first muffler 4, which is an expansion chamber muffler, in the exhaust passage 3 increases the frequencies of specific frequency components intended to be attenuated. With reference to FIG. 3, the stationary waves 13 to 15 formed by the first muffler 4 are high in frequency, as compared with the stationary wave 11 of the first mode (see FIG. 2) that is formed in the case where the first muffler 4 is not installed. In other words, installation of the first muffler 4 in the exhaust passage 3 eliminates the stationary wave 11 in a low frequency region and increases the frequencies of the frequency components intended to be attenuated.

Accordingly, the capacity of the resonance chamber of the second muffler 5 can be reduced. The configuration of the present embodiment, therefore, provides the muffling effect by the resonance phenomenon and contributes to reducing the size of the resonance-type second muffler 5.

(1c) In the present embodiment, the second muffler 5 is situated at the position (see FIG. 3) where the antinode of the stationary wave 14 is formed by the first muffler 4.

The muffler system 1 can effectively reduce the stationary waves, as compared with a configuration in which the second muffler 5 is situated elsewhere other than at the positions where the antinodes of the stationary waves 14, 15 are formed by the first muffler 4.

In FIG. 3, the upstream end of the second muffler 5 is situated at the position of the antinode of the stationary wave 14; other portions of the second muffler 5 may be situated at the antinode of the stationary wave 14. It is understood herein that the second muffler 5 is situated at the antinode of the stationary wave 14 as long as at least one portion of the second muffler 5 is situated at the antinode of the stationary wave 14.

(1d) In the present embodiment, the second muffler 5 is situated at the position where the antinode of the stationary wave 14 of the first mode is formed by the first muffler 4.

The muffler system 1 of the present embodiment thus can effectively reduce the stationary wave 11 of the first mode, as compared with a configuration in which the second muffler 5 is situated elsewhere other than at the position of the antinode of the stationary wave 11.

### 2. Second Embodiment

### 2-1. Differences from First Embodiment

The muffler system according to the second embodiment has the same basic configuration as in the first embodiment. Accordingly, only the differences will be described below. The components with the same reference numerals as in the first embodiment are identically configured. For details of such components, see the description given above.

As shown in FIG. 3, the second muffler 5 is situated at the position where the antinode of the stationary wave 14 of the first mode is formed by the first muffler 4 in the above-described first embodiment.

Referring now to FIG. 4, the second muffler 5 is situated at the position where the antinode of the stationary wave 15 of the second mode is formed by the first muffler 4 in the second embodiment.

Specifically, the second muffler 5 is situated at the position where the upstream antinode out of the two antinodes of the stationary wave 15 of the second mode is formed by the first muffler 4. In other words, the second muffler 5 is situated at a second position that is located away from the downstream end 3b of the exhaust passage 3 by three fourth of a wavelength λ₅ of the stationary wave 15 of the second mode.

### 2-2. Effects

The above-described muffler system according to the second embodiment further achieves the following effect in addition to the effects (1a) to (1c) acquired in the first embodiment.

(2a) In the present embodiment, the second muffler 5 is situated at the position where the antinode of the stationary wave 15 of the second mode is formed by the first muffler 4. The antinode of the stationary wave 15 of the second mode corresponds to a portion of the exhaust passage 3 where the sound pressure of the stationary wave 14 of the first mode applies. Accordingly, the muffler system of the present embodiment can effectively reduce both the stationary wave 14 of the first mode and the stationary wave 15 of the second mode.

### 3. Third Embodiment

### 3-1. Configuration

The muffler system according to the third embodiment has the same basic configuration as in the first embodiment. Accordingly, only the differences will be described below. The components with the same reference numerals as in the first embodiment are identically configured. For details of such components, see the description given above.

In the first embodiment, the second muffler 5 disposed downstream of the first muffler 4 is a resonance type muffler.

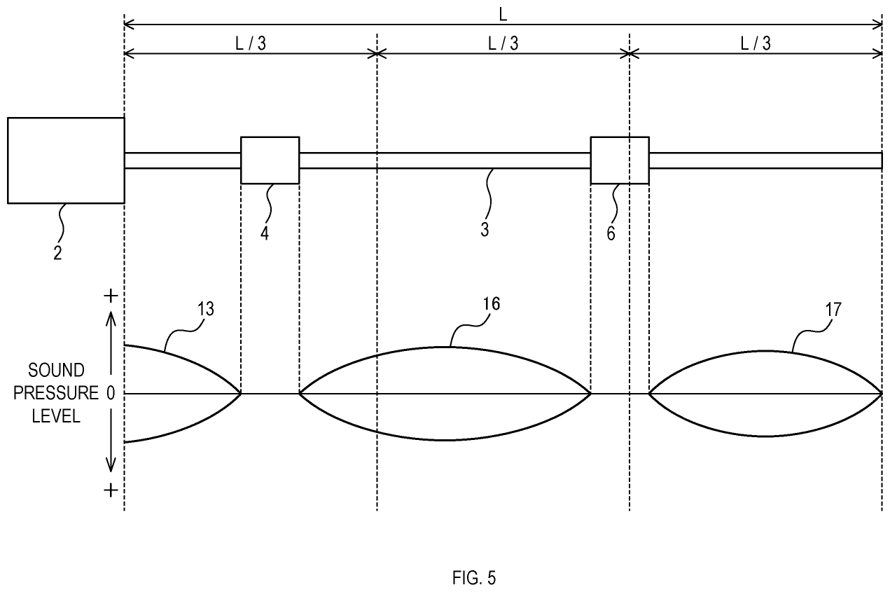

In the third embodiment shown in FIG. 5, the muffler system comprises a second muffler 6 that is an expansion chamber muffler. Apart from the type of the second muffler 6, the muffler system in the third embodiment has the same configuration as in the first embodiment.

### 3-2. Effects

The above-described muffler system according to the third embodiment further achieves the following effect in addition to the effect (1a) and the effects (1c) to (1d) acquired in the first embodiment.

(3a) In the present embodiment, the second muffler 6 is an expansion chamber muffler. Accordingly, the frequencies of the stationary waves formed in the exhaust passage 3 can be further increased.

Specifically, installation of the second muffler 6, which is an expansion chamber muffler, makes the waveforms of the stationary waves as shown in FIG. 5. A stationary wave 16 formed between the first muffler 4 and the second muffler 6 has a frequency higher than that of the stationary wave 14 (see FIG. 3) that is formed in the case where the second muffler 6 is not installed. A stationary wave 17 formed downstream of the second muffler 6 also has a frequency higher than that of the stationary wave 14.

Accordingly, installing the second muffler 6 further increases the frequencies of the stationary waves to be formed in the exhaust passage 3. Making the stationary waves high-frequency waves leads to reducing the sound pressure levels of the stationary waves in low frequencies, which in turn reduces the exhaust noises.

### 4. Fourth Embodiment

### 4-1. Configuration

The muffler system according to the fourth embodiment has the same basic configuration as in the third embodiment. Accordingly, only the differences will be described below. The components with the same reference numerals as in the third embodiment are identically configured. For details of such components, see the description given above.

In the third embodiment, the second muffler 6, which is an expansion chamber muffler, is situated at the position where the antinode of the stationary wave 14 of the first mode is formed by the first muffler 4 as in the first embodiment. In the fourth embodiment, the second muffler 6, which is an expansion chamber muffler, is situated at the position where the antinode of the stationary wave 15 of the second mode is formed by the first muffler 4 as in the second embodiment. Other than the position of the second muffler 6, the muffler system of the fourth embodiment has the same configuration as in the third embodiment.

### 4-2. Effects

The above-described muffler system according to the fourth embodiment achieves the effects (1a) and (1c) acquired in the first embodiment and the effect (2a) acquired in the second embodiment.

### 5. Other Embodiments

Embodiments of the present disclosure have described hereinabove; the present disclosure, however, should not be limited to the above-described embodiments and may be carried out in variously modified manners.

(1) The second mufflers 5, 6 in the second and fourth embodiments are situated at the position where the upstream antinode out of the two antinodes (see FIG. 4) of the stationary wave 15 of the second mode is formed by the first muffler 4. The positions of the second mufflers 5, 6, however, are not limited to this position.

For example, the second mufflers 5, 6 may be situated at the position where the downstream antinode out of the two antinodes of the stationary wave 15 of the second mode is formed by the first muffler 4. In other words, the second muffler 5 may be situated at a position that is located away from the downstream end 3b of the exhaust passage 3 by one fourth of the wavelength λ₅ of the stationary wave 15 of the second mode.

As in the second and fourth embodiments, both the stationary wave 14 of the first mode and the stationary wave 15 of the second mode can be also effectively reduced in this configuration.

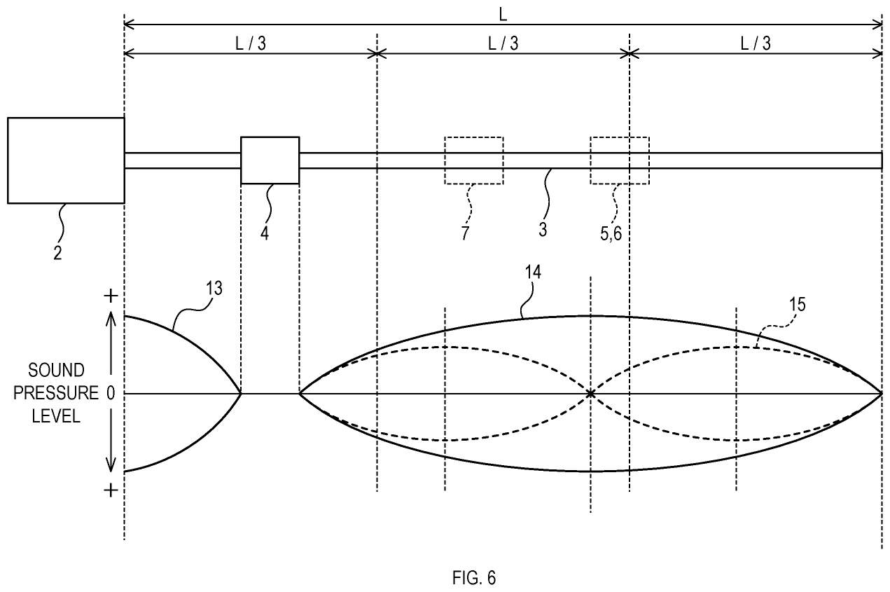

(2) In each embodiment described above, the muffler system comprises two mufflers (namely, the first muffler 4 and the second muffler 5 or 6). The number of mufflers in the muffler system is not limited to two. The muffler system may comprise, for example, three mufflers. As shown in FIG. 6, the muffler system may comprise, for example, the first muffler 4, and the second muffler 5 or 6 and a third muffler 7 that are disposed downstream of the first muffler 4. The second muffler 5 or 6 and the third muffler 7 are each a resonance type muffler or an expansion chamber muffler. The second muffler 5 or 6 may be situated at the position where the antinode of the stationary wave 14 of the first mode is formed by the first muffler 4. The third muffler 7 may be situated at the position where the antinode of the stationary wave 15 of the second mode is formed by the first muffler 4. FIG. 6 shows the waveforms of stationary waves that are formed in the case where only the first muffler 4 is installed and the second muffler 5 or 6 and the third muffler 7 are not installed (that is, as in FIG. 2).

The muffler system with the above-described configuration can effectively reduce both the stationary wave 14 of the first mode and the stationary wave 15 of the second mode.

The muffler system may comprise four or more mufflers.

(3) Functions of one component in the aforementioned embodiments may be achieved by two or more components, and a function of one component may be achieved by two or more components. Moreover, functions of two or more components may be achieved by one component, and a function achieved by two or more components may be achieved by one component. Furthermore, a part of the configurations of the aforementioned embodiments may be omitted. At least a part of the configurations of the aforementioned embodiments may be added to or replaced with other configurations of the aforementioned embodiments.

What is claimed is:

1. A muffler system comprising:
an exhaust passage configured to allow a flow of an exhaust gas; and
a first muffler that is an expansion chamber muffler and disposed in the exhaust passage,
wherein the first muffler is situated upstream of a first position in a flow direction of the exhaust gas, the first position being located away from an upstream end of the exhaust passage by one third of an entire length of the exhaust passage.

2. The muffler system according to claim 1, further comprising a second muffler,
wherein the second muffler is either a resonance type muffler or an expansion chamber muffler and disposed downstream of the first muffler in the exhaust passage.

3. The muffler system according to claim 2,
wherein the second muffler is the resonance type muffler.

4. The muffler system according to claim 2,
wherein the second muffler is the expansion chamber muffler.

5. The muffler system according to claim 2,
wherein the second muffler is situated at a position where an antinode of a stationary wave is formed by the first muffler.

6. The muffler system according to claim 5,
wherein the second muffler is situated at a position where an antinode of a stationary wave of a first mode is formed by the first muffler.

7. The muffler system according to claim 5,
wherein the second muffler is situated at a position where an antinode of a stationary wave of a second mode is formed by the first muffler.

8. The muffler system according to claim 5, further comprising a third muffler,
wherein the third muffler is either a resonance type muffler or an expansion chamber muffler and disposed downstream of the first muffler in the exhaust passage, and
wherein the second muffler is situated at a position where an antinode of a stationary wave of a first mode is formed by the first muffler, and the third muffler is situated at a position where an antinode of a stationary wave of a second mode is formed by the first muffler.
